(19) United States
(12) Patent Application Publication
(10) Pub. No.: US 2007/0155377 A1
(43) Pub. Date: Jul. 5, 2007

(54) Cellular communication system, management station and communication control method

(76) Inventors: Tomoya Horiguchi, Yokohama-Shi (JP); Noritaka Deguchi, Kawasaki-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,292

(22) Filed: Dec. 18, 2006

(30) Foreign Application Priority Data
Dec. 22, 2005 (JP) 2005-370080

(51) Int. Cl. H04Q 7/20

(52) U.S. Cl. 455/422.1

(57) ABSTRACT

There is provided with a communication control method including: measuring signal quality of signals which reach a terminal device from base stations; determining one or more base station to communicate with the terminal device based on the signal quality, and transmitting an instruction signal to instruct to communicate between determined base stations and the terminal device on a time-division scheme to the base stations and transmitting an instruction signal to instruct stoppage of communication to a base station determined not to communicate with the terminal, when a change of the base stations to communicate with the terminal device occurs and the number of base stations is two or more after the change.

### CROSS-REFERENCE TO RELATED APPLICATIONS

This application is based upon and claims the benefit of priority from the prior Japanese Patent Applications No. 2005-370080 filed on Dec. 22, 2005, the entire contents of which are incorporated herein by reference.

### BACKGROUND OF THE INVENTION

1. Field of the Invention

The present invention relates to a cellular communication system, management station and communication control method, and more particularly, to an inter-cell interference suppression technology for a 1-cell frequency repetition cellular communication system using a multicarrier communication scheme.

2. Related Art

As an example of a technology for suppressing inter-cell interference in a conventional 1-cell frequency repetition cellular communication system, there is one whereby a base station transmits signals for only a predetermined period (for example, see JP-A 2001-231077(KOKAI) as a first document).

Also, there is one which adopts an OFDMA (Orthogonal Frequency Division Multiple Access) communication scheme whereby communications are carried out using only subcarriers specified for each user, among other conventional technologies (for example, see IEEE Standard for Local and metropolitan area networks. Part 16: Air Interface for Fixed Broadband Wireless Access Systems (Revision of IEEE Std 802.16-2001) 8.4 Wireless MAN-OFDMAPHY as a second document).

When focused on a specific cell according to the method described in the first document, there is a certain period during which though there is geographically no interference signal for a certain period, no signal can be sent/received at all and when the number of time-multiplexed cells increases, there is a problem that the throughput of the whole system decreases in proportion to the number of the cells.

Furthermore, according to the method described in the second document, it is difficult to simultaneously correct a clock frequency, Doppler frequency, transmission timing or the like for each communication destination when communicating with a plurality of communication destinations resulting in a problem that reception performance deteriorates.

### SUMMARY OF THE INVENTION

According to an aspect of the present invention, there is provided with a cellular communication system comprising:

a plurality of base stations whose respective communication areas partially overlap with each other and each of which uses a same frequency band;

a terminal device configured to communicate with the base stations; and

a management station configured to manage the base stations,

wherein the terminal device includes:

a signal quality measuring section configured to measure quality of signals from the base stations;

a first communication section configured to communicate with one of the base stations using first subcarriers out of subcarriers included in the same frequency band; and

a second communication section configured to communicate with two or more of the base stations on a time-division scheme using second subcarriers different from the first subcarriers out of the subcarriers included in the same frequency band,

each of the base stations includes:

a third communication section configured to communicate with the terminal device using the first subcarriers; and

a fourth communication section configured to communicate with the terminal device on the time-division scheme using the second subcarriers together with one or more other base stations;

the management station includes:

a quality information reception section configured to receive information indicating signal quality of the base stations measured at the terminal device from the terminal device through at least one base station with which the terminal device is communicating; and

a communication scheme determining section configured to
determine one or more base station to communicate with the terminal device based on the signal quality of the base stations,
transmit an instruction signal to instruct to communicate with the terminal device using the first subcarriers to a base station determined to communicate with the terminal device and transmit an instruction signal to instruct stoppage of communication to a base station determined not to communicate with the terminal device among the base stations with which the terminal device has communicated, when a change of the base stations to communicate with the terminal device occurs as a result of determination and the number of base station is one after the change, and
transmit an instruction signal to instruct to communicate between base stations determined to communicate with the terminal device and the terminal device using the second subcarriers to the base stations and transmit an instruction signal to instruct stoppage of communication to a base station determined not to communicate with the terminal in a case that the base station determined not to communicate with the terminal exists among the base stations with which the terminal device has communicated, when a change of the base stations to communicate with the terminal device occurs as the result of determination and the number of base stations is two or more after the change.

According to an aspect of the present invention, there is provided with a management station of managing a plurality of base stations whose respective communication areas partially overlap with each other and each of which uses a same frequency band, comprising:

a quality information reception section configured to receive information indicating signal quality of signals which reach a terminal device from the base stations, through at least one base station with which the terminal is communicating; and

a communication scheme determining section configured to
determine one or more base station to communicate with the terminal device based on the signal quality of the base stations,
transmit an instruction signal to instruct to communicate with the terminal device using first subcarriers out of subcarriers included in the same frequency band to a base station determined to communicate with the terminal device and transmit an instruction signal to instruct stoppage of communication to a base station determined not to communicate with the terminal device among the base stations with which the terminal device has communicated, when a change of the base stations to communicate with the terminal device occurs as the result of determination and the number of base stations is one after the change,
transmit an instruction signal to instruct to communicate between base stations determined to communicate with the terminal device and the terminal device using second subcarriers different from the first subcarriers out of subcarriers included in the same frequency band to the base stations and transmit an instruction signal to instruct stoppage of communication to a base station determined not to communicate with the terminal device in a case that the base station determined not to communicate with the terminal device exists among the base stations which the terminal device has communicated, when a change of the base stations to communicate with the terminal device occurs as the result of determination and the number of base stations is two or more after the change.

According to an aspect of the present invention, there is provided with a communication control method executed in a cellular communication system which includes a terminal device and a plurality of base stations whose respective communication areas partially overlap with each other and each of which uses a same frequency band, comprising:

measuring signal quality of signals which reach the terminal device from the base stations;

determining one or more base station to communicate with the terminal device based on the signal quality of the base stations, transmitting an instruction signal to instruct to communicate with the terminal device using first subcarriers out of subcarriers included in the same frequency band to a base station determined to communicate with the terminal device and transmitting an instruction signal to instruct stoppage of communication to a base station determined not to communicate with the terminal device among base stations with which the terminal have communicated, when a change of the base stations to communicate with the terminal device occurs as a result of the determining and the number of the base station is one after the change, and

transmitting an instruction signal to instruct to communicate between base stations determined to communicate with the terminal device and the terminal device using second subcarriers different from the first subcarriers out of subcarriers included in the same frequency band on a time-division scheme to the base stations and transmitting an instruction signal to instruct stoppage of communication to a base station determined not to communicate with the terminal device in a case that the base station determined not to communicate with the terminal device exits among base stations with which the terminal have communicated, when a change of the base stations to communicate with the terminal device occurs as a result of the determining and the number of base stations is two or more after the change.

### BRIEF DESCRIPTION OF THE DRAWINGS

FIG. 1 is a block diagram showing a configuration example of a cellular communication system as an embodiment of the present invention;

FIG. 2 shows an example of arrangement of subcarriers for a cell central part and subcarriers for a cell edge when using an OFDM (Orthogonal Frequency Division Multiplexing) communication scheme (1);

FIG. 3 shows another example of arrangement of subcarriers for a cell central part and subcarriers for a cell edge when using an OFDM communication scheme (2);

FIG. 4 shows an example of arrangement of subcarriers for a cell central part and subcarriers for a cell edge when using a frequency multicarrier communication scheme;

FIGS. 5A-5E show examples of transmission timing of a base station 101, base station 102 and reception timing of terminal device 103, terminal device 104 and terminal device 105;

FIG. 6 shows an example of a position registration sequence diagram;

FIG. 7 shows an example of a sequence diagram when a request for starting a communication from a network side to a terminal device is generated;

FIG. 8 shows an example of a sequence diagram when a request for starting a communication from the terminal device side to the network side is generated;

FIG. 9 shows an example of a sequence diagram when the terminal device moves from a cell central part to a cell edge;

FIG. 10 shows an example of a sequence diagram when the terminal device moves from a cell edge to a cell central part;

FIG. 11 shows a flow example of communication subcarrier change decision (1);

FIG. 12 shows a flow example of communication subcarrier change decision (2);

FIG. 13 is a block diagram showing a configuration example of a terminal device as an embodiment of the present invention;

FIG. 14 is a block diagram showing a configuration example of a base station and management station as an embodiment of the present invention; and

FIG. 15 is a flow chart showing a example of determining subcarriers that should be used to carry out a communication when three or more base stations exist.

### DETAILED DESCRIPTION OF THE INVENTION

Hereinafter, this embodiment will be explained in detail with reference to the attached drawings.

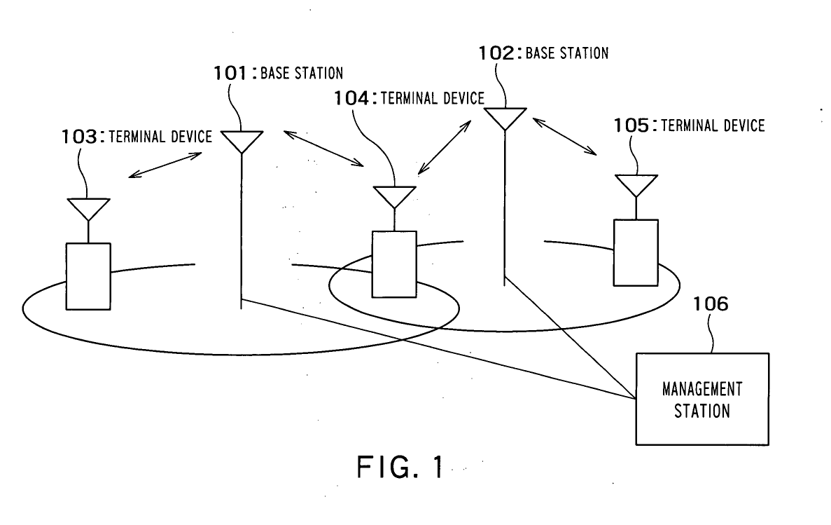

FIG. 1 shows a configuration example of a cellular communication system as an embodiment of the present invention.

A base station 101 and base station 102 can exchange information with a management station 106 using wired or wireless means. The range (communication area) where the base station 101 and base station 102 can provide services to terminal devices partially overlaps. For example, a terminal device 103 and a terminal device 105 can receive services by communicating with the base station 101 and the base station 102 respectively using a multicarrier radio communication scheme. Furthermore, a terminal device 104 can receive services from the base station 101 and the base station 102. Here, for simplicity, only two cells are described, but the management station can manage a plurality of, that is, three or more base stations. Here, the base station 101 and base station 102 are geographically separated from each other but the base station 101 and base station 102 may also exist within one cell. For example, one sector may be divided into a plurality of sectors and a base station provided with a directional antenna may be arranged for each sector. Furthermore, a base station and a management station may also be mounted in the same apparatus.

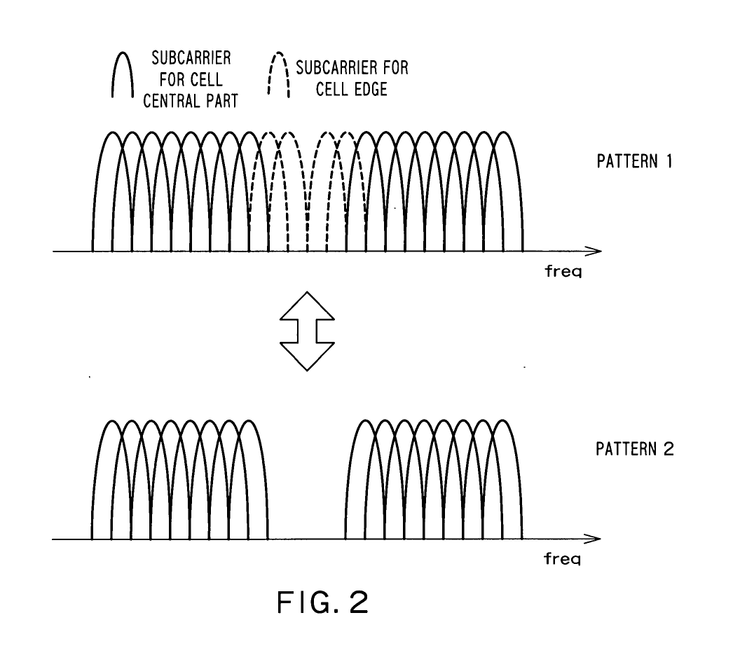

FIG. 2 shows an arrangement example of subcarriers (first subcarriers) for a cell central part and subcarriers (second subcarriers) for a cell edge when using an OFDM (Orthogonal Frequency Division Multiplexing) communication scheme of multicarrier communication schemes.

Since the terminal device 103 is at a position where signals from base stations except the base station 101 do not reach, the base station 101 communicates with the terminal device 103 using subcarriers for a cell central part. In a similar fashion, the base station 102 communicates with the terminal device 105 using subcarriers for a cell central part. At this time, since the signals of the base station 101 and terminal device 103 and signals of the base station 102 and terminal device 105 are geographically separated from each other, even if communications are performed at the same frequency and the same time, communications can be carried out without any interference with each other. Uplink communications from a terminal device to a base station and downlink communications from a base station to a terminal device are divided using time division multiplexing (TDD), frequency division multiplexing (FDD) or the like. Furthermore, when a plurality of terminal devices which communicate using subcarriers for a cell central part exist, access may be made using time division multiple access (TDMA), frequency division multiple access (FDMA), orthogonal frequency division multiple access (OFDMA), spreading code division multiple access (CDMA) or the like. For the terminal device 104 which is situated at an intermediate position between the base station 101 and base station 102, when the base station 101 and base station 102 perform transmission at the same frequency and the same time, this produces inter-cell interference and causes the communication quality to deteriorate. In order to prevent this, the base station 101 and base station 102 each transmit a signal to the terminal device 104 using subcarriers for a cell edge and on a time-division scheme. For the purpose of the time-division, the output signal powers of the base station 101 and 102 repeats pattern 1 and pattern 2 of FIG. 2. In pattern 1, both of the subcarriers for a cell central part and the subcarriers for a cell edge are used and in pattern 2, only the subcarriers for a cell central part are used. Furthermore, when there are a plurality of terminal devices which communicate using the subcarriers for a cell edge, communications may be multiplexed using TDMA, FDMA, OFDMA, CDMA as in the case of a user multiplexing scheme of the subcarriers for a cell central part.

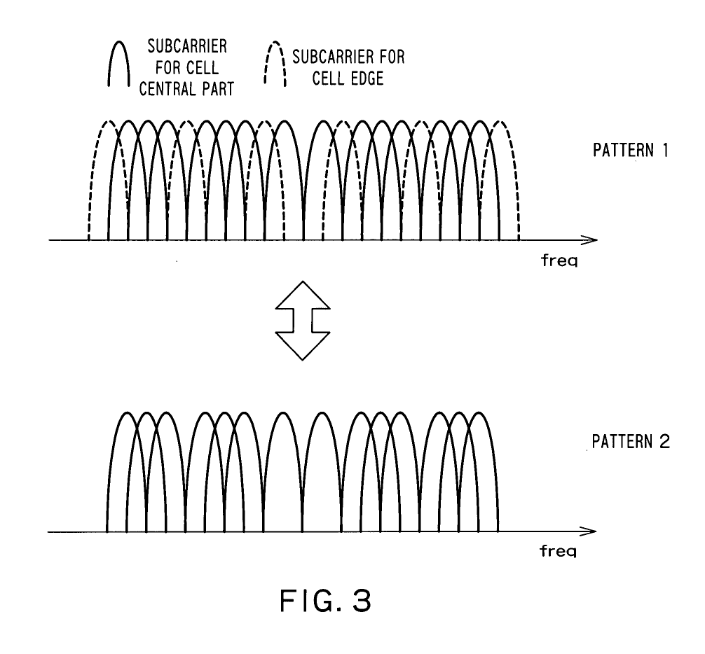

FIG. 3 shows an example of arrangement of subcarriers for a cell central part and subcarriers for a cell edge which is different from that of FIG. 2.

In the example of FIG. 3, subcarriers for a cell edge are arranged such that three subcarriers for a cell central part are arranged between two subcarriers for a cell edge so as to widen the frequency interval among the subcarriers for a cell edge considerably. In the same way as FIG. 2, the base station 101 and base station 102 each transmit signals to the terminal device 104 using subcarriers for a cell edge on a time-division scheme. In this way, by determining subcarriers for a cell edge by avoiding neighboring subcarriers, the correlation among subcarriers for a cell edge decreases and effects of frequency diversity (spatial diversity effect) can be expected.

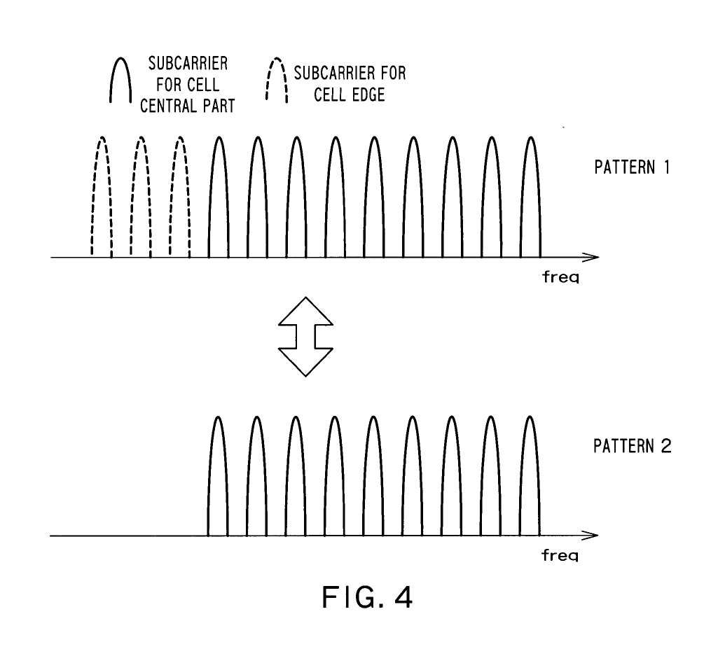

FIG. 4 shows an example of arrangement of subcarriers for a cell central part and subcarriers for a cell edge in the frequency multicarrier communication scheme.

Unlike FIG. 2, FIG. 3, instead of OFDM signals, the example of FIG. 4 shows multicarrier signals whose frequencies are independent of each other. Uplink communications from a terminal device to a base station and downlink communications from a base station to a terminal device are divided using time division multiplexing (TDD) and frequency division multiplexing (FDD) or the like. Furthermore, when there are a plurality of terminal devices which perform communications using subcarriers for a cell central part, it is possible to get access to the base station using time division multiple access (TDMA), frequency division multiple access (FDMA), spreading code division multiple access (CDMA) or the like. Furthermore, when there are a plurality of terminal devices which communicate using subcarriers for a cell edge, it is also possible to multiplex them using TDMA, FDMA, CDMA or the like as in the case of the user multiplexing scheme of subcarriers for a cell central part.

Low-frequency band signals are generally known to be likely to also receive an NLOS (None Line Of Sight) radio wave because of the nature of reflection and diffraction that the radio wave has. Therefore, by arranging subcarriers for a cell edge on the low frequency side as shown in FIG. 4, it is possible to perform communications with higher quality also for an NLOS terminal device which exists at the cell edge. On the other hand, because reception power of a terminal device which exists in center part of a cell is high, even signals in a high frequency band can realize reception of high quality.

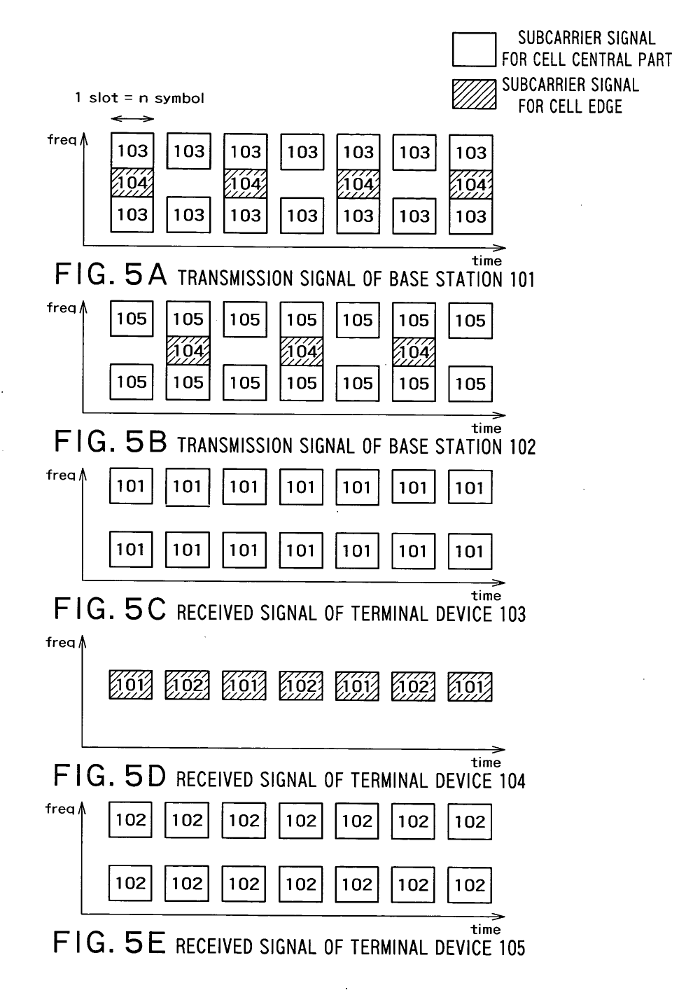

FIG. 5A to 5E shows examples of transmission timing of the base station 101 and base station 102, and reception timing of the terminal device 103, terminal device 104 and terminal device 105 when the subcarrier arrangement in FIG. 2 is adopted for downlink communications. This example shows a case where subcarriers for a cell edge are time-divided among the base stations in slot units. Here, 1 slot is a unit which is made up of n OFDM symbols (n is a natural number). 1 slot includes pilot symbols for timing and frequency synchronization and data symbols to transmit data. As shown in FIG. 5A, the base station 101 transmits signals to the terminal device 103 every slot using subcarriers for a cell central part. Furthermore, simultaneously with this, the base station 101 transmits signals to the terminal device 104 at intervals of 1 slot using subcarriers for a cell edge. Likewise, as shown in FIG. 5B, the base station 102 transmits signals to the terminal device 105 at intervals of 1 slot using subcarriers for a cell central part. Furthermore, simultaneously with this, the base station 102 transmits signals to the terminal device 104 every slot using subcarriers for a cell edge. At this time, the management station 106 adjusts timing such that transmission slot timing of transmission signals from the base station 101 to the terminal device 104 does not overlap transmission slot timing of the transmission signals from the base station 102 to the terminal device 104. Here, the case with only 2 cells is explained, but in the case with 3 or more cells as well, only a base station in one cell carries out transmission using subcarriers for a cell edge and base stations in the other cells do not perform transmission in the meantime.

As shown in FIG. 5C, the terminal device 103 receives only signals of subcarriers for a cell central part out of the transmission signals from the base station 101. At this time, the terminal device 103 can also receive signals of subcarriers for a cell edge which the base station 101 is transmitting to the terminal device 104, but these signals are ignored in the terminal device 103 in this example. In the same way, as shown in FIG. 5E, the terminal device 105 also receives only subcarriers for a cell central part out of the transmission signals of the base station 102. On the other hand, as shown in FIG. 5D, the terminal device 104 alternately receives signals of subcarriers for a cell edge which the base station 101 and the base station 102 transmit. Since signals which the base station 101 and the base station 102 transmit reach the terminal device 104, the subcarriers for a cell central part received consist of the transmission signals from the base station 101 and the transmission signals from the base station 102 overlapping with each other. This causes an SINR to rise and the reception performance deteriorates considerably. However, subcarriers for a cell edge for signals of the base station 101 and base station 102 are temporally shifted and never overlap with each other, and therefore the SINR can be suppressed to a low level. Therefore, a terminal device which exists at a cell edge can also carry out a communication of high quality.

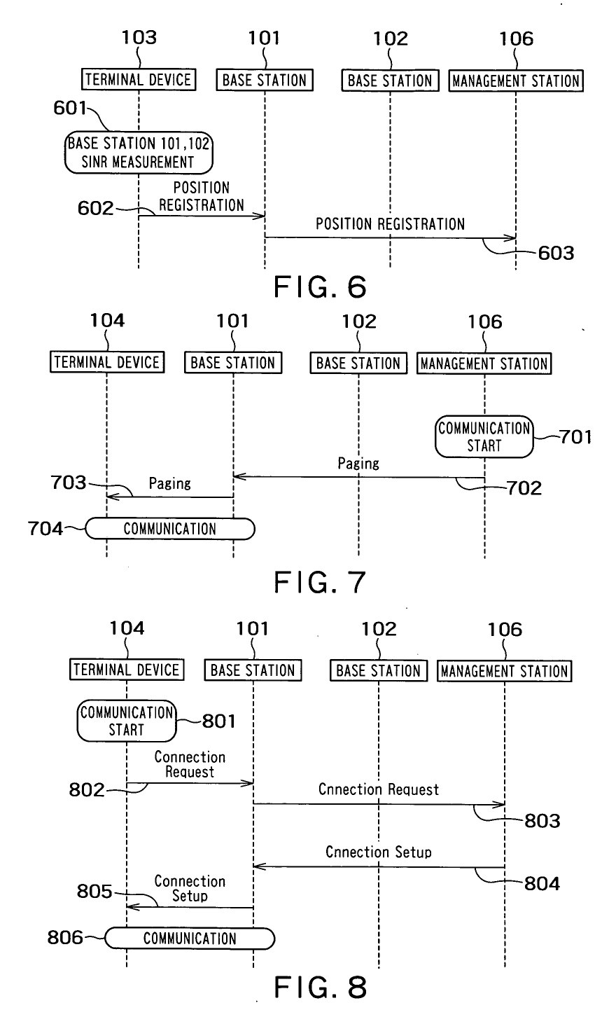

FIG. 6 shows a sequence diagram for a terminal device to register the position of the terminal device in the base station and the management station.

The terminal device receives a synchronization signal, pilot signal and report signal from the base station when power is turned on or on a regular basis and informs the position of the terminal device to the base station which is estimated to be located close to the terminal device from the power of the terminal device as position registration information. Here, the “synchronization signal” is a signal for realizing synchronization to receive a pilot signal and a report signal, the “pilot signal” is a signal for performing transmission path estimation and measurement of reception power and noise power and the “report signal” is a signal for notifying the ID of the base station and information on peripheral cells or the like to terminal devices in the cell. These signals do not require a high data rate and are signals that must be transmitted to the terminal devices without fail. Therefore, these signals may be assigned on subcarriers for a cell edge to make sure that these signals are notified not only to terminal devices which exist at a cell edge but also to terminal devices which exist at a cell central part using subcarriers for a cell edge. In this example, the terminal device 103 receives synchronization signals and pilot signals which the nearby base stations are transmitting regularly and measures SINRs (601). The terminal device 103 selects the base station 101 which has the highest SINR from among these base stations. When the selected base station differs from the previous one or when power is turned on, the terminal device 103 transmits information that it is located near the base station 101 as position registration information (602). The base station 101 notifies the notified position registration information to the management station 106 (603). Here, the position registration information includes the ID of the terminal device and the ID of the base station and may also include an SINR. At this time, in the case of the terminal device 104 located at the cell edge, any one of the base station 101 and base station 102 is selected from the measurement result of the SINR and position registration information is notified to the management station 106. This allows the management station 106 to know terminal devices that exist in the cells under the own control.

FIG. 7 shows a sequence diagram when the management station requests the terminal device 104 to start a communication. An example of this may be a case where a terminal device which is in a different area sends a request for a communication to the terminal device 104.

When a communication start request (701) is generated, the management station 106 instructs the base station 101 which exists near the terminal device 104 according to the position registration information of the terminal device 104 to perform paging (call up notice) to the terminal device 104 (702). The base station 101 transmits a paging signal to the terminal device 104 which seems to be located close to the base station 101 (703). The terminal device 104 which has received the paging signal starts a communication with the base station 101 (704). The method of starting a communication will be described later (FIG. 8). In the example of FIG. 7, only the base station 101 is performing paging to the terminal device 104, but when the resolution of the position in the position registration information is not a 1-cell unit but a unit of a plurality of cells, paging may also be performed from a plurality of base stations. In this case, the terminal device 104 specifies a base station using an appropriate method and starts a communication.

Here, there can be two methods of notifying paging; one using subcarriers for a cell edge and the other using subcarriers for a cell central part.

When communication is performed using subcarriers for a cell edge at the time of paging and at the start of a communication, signals are transmitted on a time-division scheme, and therefore even if the terminal device exists at a cell edge, there is an advantage that it is possible to reduce interference among the cells to a low level. In this case, when the terminal device moves from the cell edge to the cell central part, it is necessary to promptly switch over to subcarriers for a cell central part and carry out a communication using a method which will be described later. When the terminal device is located at the cell edge, the terminal device carries out a communication using subcarriers for a cell edge as is.

When a communication is performed using subcarriers for a cell central part at the time of paging and at the start of a communication, if the terminal device exists at the cell edge, the transmission signal of the base station 102 becomes interference, but a communication is started using an interference-resistant modulation scheme such as BPSK or increasing a spreading factor in the case of OFCDM. These methods are intended to increase resistance to interference at the sacrifice of throughput and continuing the communication in this condition will cause the throughput to decrease, and therefore it is necessary to switch over to subcarriers for a cell edge using a method which will be described later and carry out a communication.

FIG. 8 shows a sequence diagram when the terminal device requests the management station to start a communication. This may apply to a case where the terminal device which has received paging starts a communication with the base station or a case where the user who has the terminal device 104 starts a communication with a terminal device in another region or the like.

When a communication start request (801) is generated, the terminal device 104 notifies Connection Request (connection request) to the base station 101 in which the position of the terminal device 104 was registered before (802). The base station 101 notifies the Connection Request from the terminal device 104 to the management station 106 (803). Here, the Connection Request requests to communicate with the base station by the terminal device using a dedicated channel and includes subscriber information and user ID or the like. When the communication is authorized, the management station 106 which has received the Connection Request from the terminal device 104 notifies Connection Setup (connection setting) to the base station 101 (804). The base station 101 which has received the Connection Setup notifies the Connection Setup to the terminal device 104 in the same way (805). Here, the Connection Setup is a notice for the management station to transmit a communication authorization to the terminal device and the terminal device which has received this can start a communication using a dedicated channel.

Here, as in the case of paging, there can be two methods of notifying Connection Request from the terminal device to the base station and Connection Setup from the base station to the terminal device; one using subcarriers for a cell edge and the other using subcarriers for a cell central part. The more specific description of the method is the same as that in the case of paging, and therefore detailed explanations will be omitted.

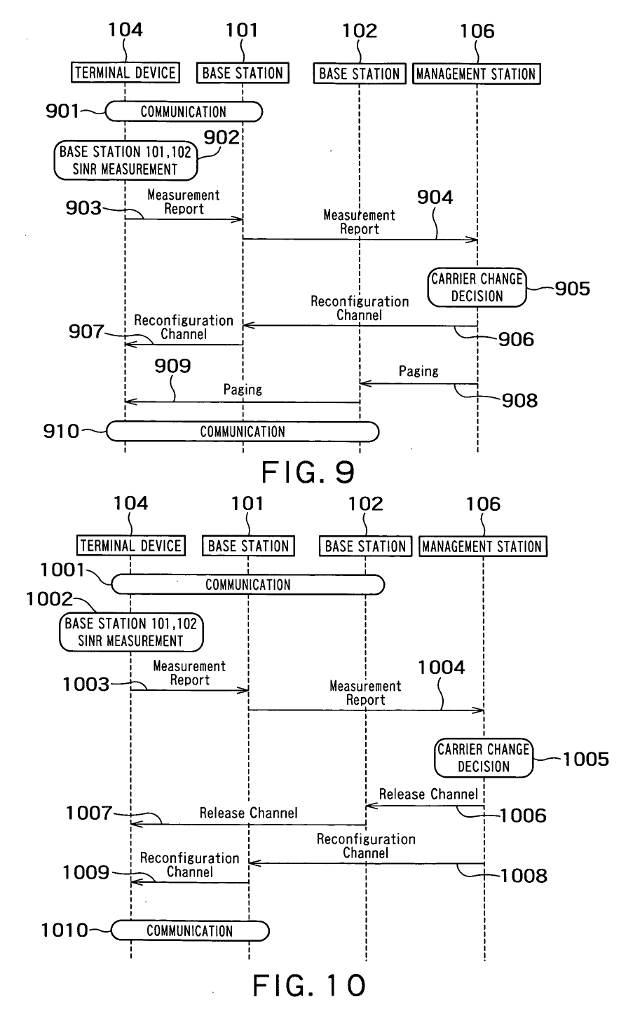

FIG. 9 shows a sequence diagram when a terminal device moves from a cell central part to a cell edge. Explanations here assume a case where the terminal device 104 moves to the cell edge while communicating at the cell central part of the base station 101 or a case where the terminal device 104 is stationary at the cell edge and starts a communication using subcarriers for a cell central part of the base station 101 at the start of a communication or the like.

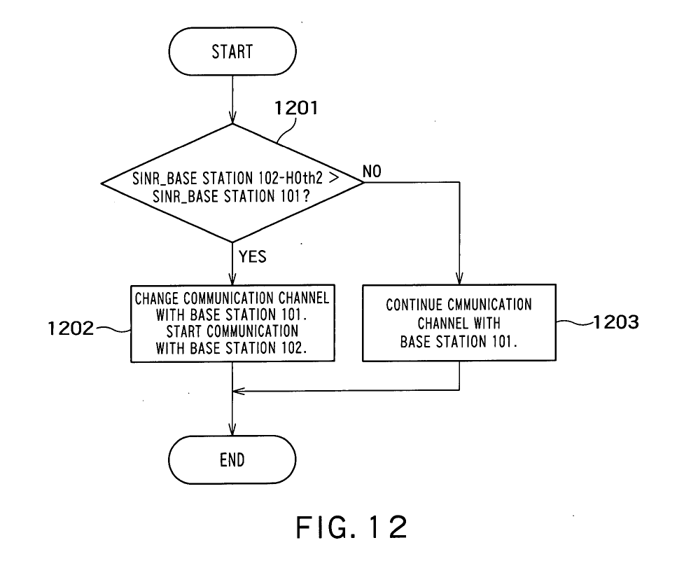

The terminal device 104 which is communicating (901) with the base station 101 using subcarriers for a cell central part is, at the same time, measuring communication quality (signal quality) of the base station 101 and base station 102 using subcarriers for a cell edge (902). In this example, an SINR is used as the communication quality, but it is also possible to combine indices such as SIR and BER to evaluate communication quality. A higher SINR or SIR indicates higher communication quality, while a lower BER indicates higher communication quality. The communication quality measurement result is regularly notified to the base station 101 using subcarriers for a cell central part as Measurement Report (903). The base station 101 notifies the Measurement Report received from the terminal device 104 to the management station 106 (904). The management station 106 judges whether or not to change over to a communication using subcarriers for a cell edge based on the notified Measurement Report (905). This decision method will be described later using FIG. 12.

When changing over to a communication using subcarriers for a cell edge, the management station 106 notifies Reconfiguration Channel (channel resetting) to the base station 101 (906), the base station 101 notifies Reconfiguration Channel to the terminal device 104 using subcarriers for a cell central part (907) and then changes the channel to be used for the communication between the terminal device 104 and base station 101 to subcarriers for a cell edge. Here, the Reconfiguration Channel notice includes an instruction and time or the like to change from subcarriers for a cell central part to subcarriers for a cell edge. Furthermore, the management station 106 notifies paging to the base station 102 (908). The base station 102 which has received the paging notifies the paging to the terminal device 104 using subcarriers for a cell edge (909). At this time, the paging from the base station 102 is temporally multiplexed with the signal from the base station 101 and never interferes with each other. While communicating with the base station 101 using subcarriers for a cell edge according to the instruction from the base station 101, the terminal device 104 waits for a paging notice from the base station 102 and establishes a communication with the base station 102. Using such a procedure, the terminal device 104 carries out a communication based on time division multiplexing with the base station 101 and base station 102 using subcarriers for a cell edge (910).

FIG. 10 shows a sequence diagram when a terminal device moves from a cell edge to a cell central part. Explanations here assume a case where the terminal device 104 moves to the cell central part while communicating at the cell edge of the base station 101 or a case where the terminal device 104 is stationary at the cell central part and starts a communication using subcarriers for a cell edge of the base station 101 at the start of a communication or the like.

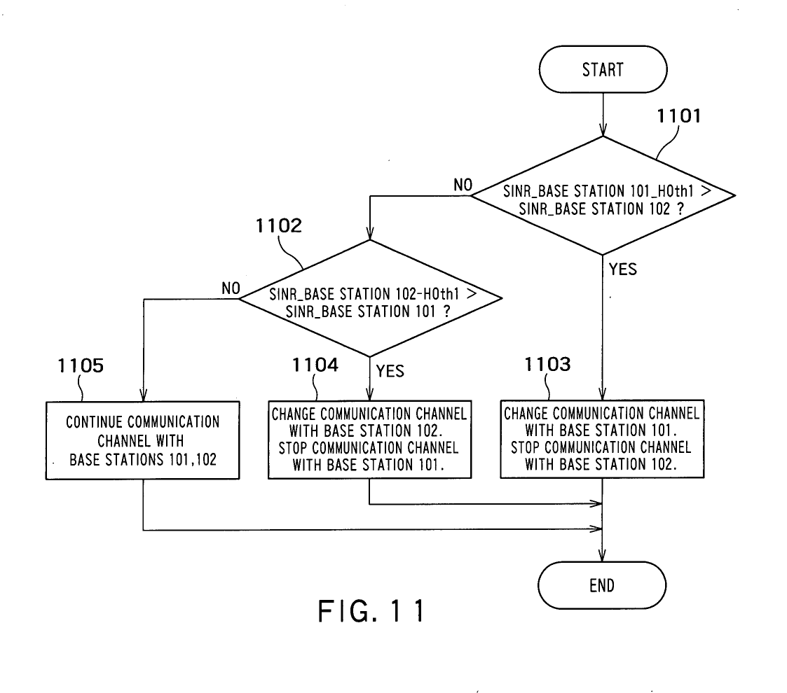

The terminal device 104 which is communicating with the base station 101 and the base station 102 using subcarriers for a cell edge (1001) is, at the same time, measuring communication quality of the base station 101 and base station 102 using subcarriers for a cell edge (1002). The communication quality measurement result is regularly notified to the base station 101 or base station 102 or both of them using subcarriers for a cell edge as Measurement Report (1003). The base station 101 or base station 102 or both of them notify the Measurement Report received from the terminal device 104 to the management station 106 (1004). The management station 106 judges whether or not to change over to a communication using subcarriers for a cell central part based on notified Measurement Report (1005). This decision method will be described later using FIG. 11. When changing over to a communication using subcarriers for a cell central part of the base station 101, the base station 102 is notified of a Release Channel (channel release) notice (1006). The base station 102 which has received this notice transmits the Release Channel notice to the terminal device 104 using subcarriers for a cell edge (1007). Here, the Release Channel notice includes an instruction for stopping the communication using subcarriers for a cell edge and a time at which the communication is stopped or the like. On the other hand, the management station 106 notifies Reconfiguration Channel to the base station 101 (1008), and the base station 101 notifies the Reconfiguration Channel to the terminal device 104 using subcarriers for a cell edge (1009), and then changes the channel to be used for the communication between the terminal device 104 and base station 101 to subcarriers for a cell central part. Here, the Reconfiguration Channel notice includes an instruction for changing from subcarriers for a cell edge to subcarriers for a cell central part and the time at which the change is executed or the like. Using such a procedure, the terminal device 104 stops the communication with the base station 102 and communicates with the base station 101 using subcarriers for a cell central part (1010).

FIG. 11 shows a flow for the management station to judge whether or not to change subcarriers used for the communication upon receiving Measurement Report of the terminal device which is carrying out a communication using subcarriers for a cell edge.

The management station which has received Measurement Report of the terminal device 104 which is communicating with the base station 101 and base station 102 using subcarriers for a cell edge evaluates:
SINR_base station 101−HOth1>SINR_base station 102 (Expression 1)

(1101), where SINR_base station 101 and SINR_base station 102 denote the communication quality measurement results of the base station 101 and base station 102 notified from the terminal device 104 and HOth1 is a threshold of a communication quality difference to change from a communication using subcarriers for a cell edge to a communication using subcarriers for a cell central part. When HOth1 is small, it is easy to change from a communication using subcarriers for a cell edge to a communication using subcarriers for a cell central part, but when HOth1 is small, changes may frequently occur and the throughput may thereby decline. This value must be specified beforehand for the system according to the size of the cell and the estimated number of terminal devices or the like.

When (Expression 1) holds (YES in 1101), the communication quality of the base station 101 is judged to be sufficiently good compared to the communication quality of the base station 102, subcarriers are changed over to subcarriers for a cell central part used for the communication of the base station 101 and the communication of the base station 102 is stopped (1103). When (Expression 1) does not hold (NO in 1101), the management station further evaluates:
SINR_base station 102−HOth1>SINR_base station 101 (Expression 2)
(1102). When (Expression 2) holds (YES in 1102), it is judged that the communication quality of the base station 102 is sufficiently good compared to the communication quality of the base station 101, and the subcarriers used for the communication of the base station 102 are changed to subcarriers for a cell central part and the communication of the base station 101 is stopped (1104).

When neither (Expression 1) nor (Expression 2) holds (NO in 1102), it is judged that there is no significant difference in communication quality between the base station 101 and base station 102 and the communication using subcarriers for a cell edge is continued (1105).

In this example, SINR is used as the value for evaluating communication quality but similar evaluation can also be performed using SIR, BER or the like. Furthermore, it is also possible to adopt a method of reducing measurement errors by taking an average of communication quality over a plurality of times.

FIG. 12 shows a flow for the management station to judge whether or not change the subcarriers used by the terminal device upon receiving Measurement Report of the terminal device which is carrying out a communication using subcarriers for a cell central part.

The management station which has received Measurement Report of the terminal device 104 which is communicating with the base station 101 using subcarriers for a cell central part evaluates:
SINR_base station 102−HOth2>SINR_base station 101 (Expression 3)
(1201), where SINR_base station 101, SINR_base station 102 are the communication quality measurement results of the base station 101 and base station 102 notified from the terminal device 104 and HOth2 is a threshold of a communication quality difference for changing from a communication using subcarriers for a cell central part to a communication using subcarriers for a cell edge. When HOth2 is small, it is easy to change from the communication using subcarriers for a cell central part to the communication using subcarriers for a cell edge, but when HOth2 is small, changes may frequently occur and the throughput may thereby decline. This value must be specified beforehand for the system according to the size of the cell and the estimated number of terminal devices or the like.

When (Expression 3) holds (YES in 1201), the communication quality of base station 102 is by no means inferior to the communication quality of the base station 101, it is possible to carry out a communication using subcarriers for a cell edge and the management station judges that the subcarriers for a cell central part of the base station 102 are causing interference with the communication between the base station 101 and terminal device 104 using the subcarriers for a cell central part. As a result, the management station changes the communication between the base station 101 and terminal device 104 to a communication using subcarriers for a cell edge while establishing a communication between the base station 102 and terminal device 104 using subcarriers for a cell edge (1202).

When (Expression 3) does not hold (NO in 1201), the management station judges that the communication quality of the base station 101 is sufficiently good compared to the communication quality of the base station 102 and continues the communication with the base station 101 using subcarriers for a cell central part (1203).

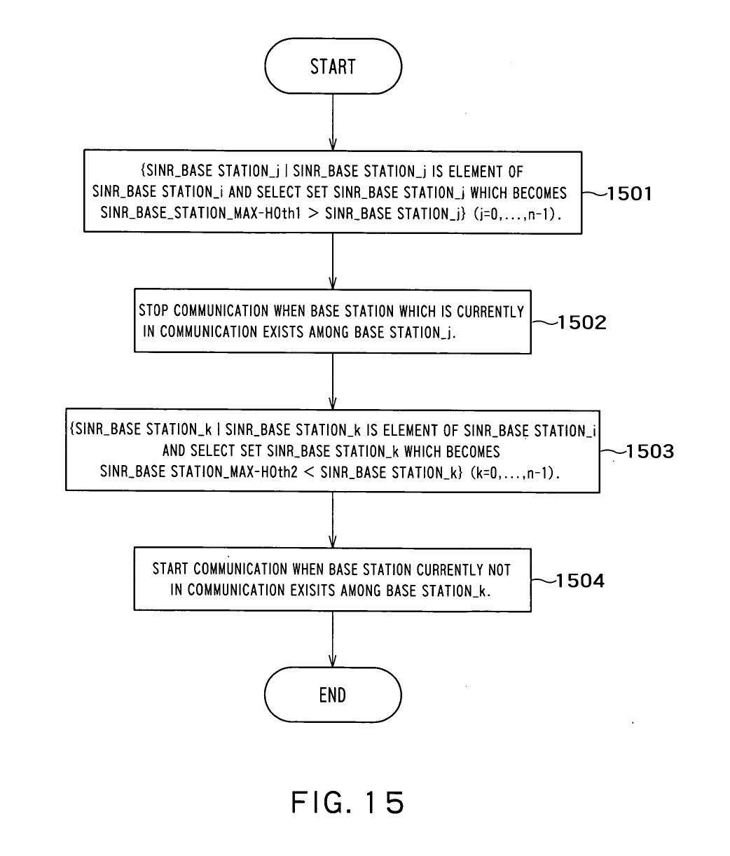

FIG. 11 and FIG. 12 have described the case where the number of base stations is 2 as an example, while FIG. 15 shows a flow example for the management station to determine subcarriers that should be used for communications when three or more base stations exist, that is, determine communication subcarriers for the base station and the terminal device.

The management station receives Measurement Report from the terminal device through the base station. Here, suppose communication quality SINR_base station_i (i is the number of a base station: an integer of 0 to n−1) for n base stations has been received. First, suppose maximum communication quality is selected from among a set SINR_base station_i and the selected value is SINR_base station_MAX. Next, from SINR_base station_i, a set SINR_base station_j which becomes:
SINR_base station_MAX−HOth1>SINR_base station_j
is selected (1501). When there is a certain base station currently in communication in the set SINR_base station_j, the management station instructs the base station to stop the communication with the terminal device (1502). Furthermore, from SINR_base station_i, a set SINR_base station_k which becomes:
SINR_base station_MAX-HOth2<SINR_base station_k
is selected (1503). When there is a certain base station currently not in communication in the set SINR_base station_k, the management station instructs the base station to start a communication with the terminal device (1504).

As a result of the flow of FIG. 15, when there are a plurality of base stations which the management station instructed to carry out a communication, communications are carried out on a time-division scheme using subcarriers for a cell edge. Furthermore, when the number of base stations which the management station instructed to carry out a communication is one, a communication is carried out using subcarriers for a cell central part.

When some base stations which communicate with the terminal device are added, the management station changes the channels which have been used so far by using Reconfiguration Channel as in the case of FIG. 9, establishes synchronization with the new base stations using paging and starts a communication. On the other hand, when the number of base stations which communicate with the terminal device is reduced, the management station stops the channels which have been used so far by using Release Channel as in the case of FIG. 10 and changes the channels which have been used so far for the remaining base stations by using Reconfiguration Channel.

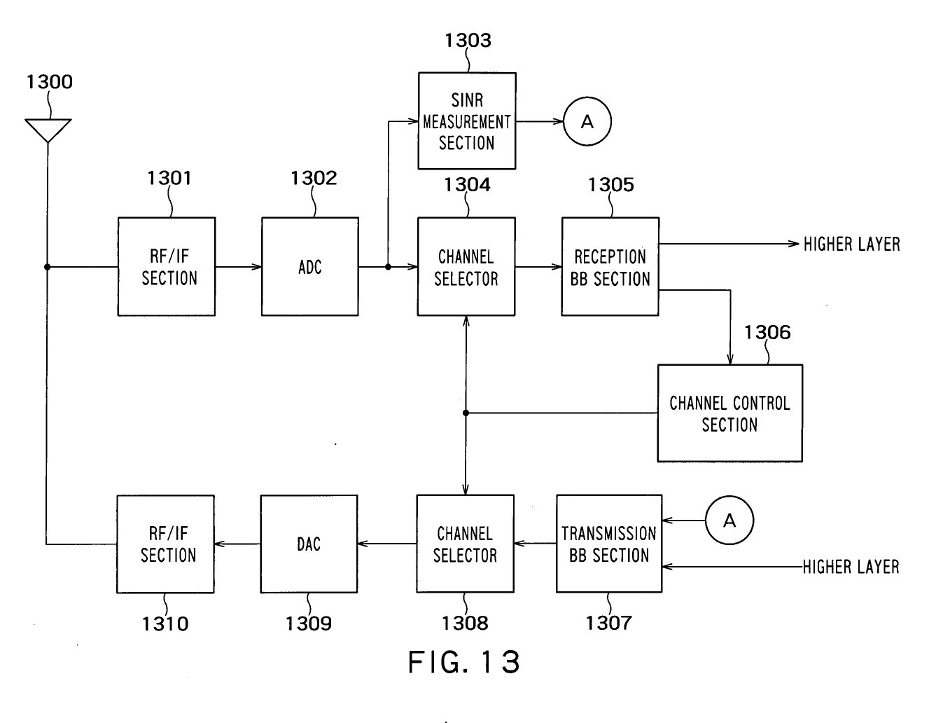

FIG. 13 is a block diagram showing the configuration of a terminal device as an embodiment of the present invention.

A signal received at an antenna 1300 is frequency-converted at an RF (Radio Frequency)/IF (Intermediate Frequency) section 1301 and then converted to a digital signal by an ADC (Analog Digital Converter) 1302. The output of the ADC 1302 is inputted to an SINR measurement section 1303 and an SINR of each base station is measured using subcarrier signals for a cell edge. Furthermore, a channel selection section (Channel Selector) 1304 selects subcarrier signals specified from a channel control section (Channel Controller) 1306 from the digital signal from the ADC 1302 and transfers it to a RXBB (Base Band) section (reception BB section) 1305. When there is no instruction from the channel control section 1306 when, for example, a communication is started, the channel selector 1304 selects a signal of predetermined subcarriers from the digital signal and transfers it to the reception BB section 1305. The reception BB section 1305 performs transmission path estimation, demodulation, error correcting decoding or the like and transfers data to a higher layer. Furthermore, the reception BB section 1305 transfers such a control signal as to specify a communication subcarrier such as a Reconfiguration Channel instruction to the channel control section 1306. The channel control section 1306 notifies the information on the subcarriers to be used for transmission/reception to the channel selectors 1304, 1308 based on the control signals from the base station transferred from the reception BB section 1305. The TxBB section (transmission BB section) 1307 multiplexes data signals from a higher layer and the measurement result from the SINR measurement section 1303, further performs processing such as error correcting coding and modulation and transfers the resultant signals to a channel selector 1308. The channel selector 1308 allocates the signals transferred from the transmission BB section 1307 to the subcarriers specified from the channel control section 1306. When there is no instruction from the channel control section 1306, for example, when a communication is started, the channel selector 1308 allocates the signals transferred from the transmission BB section 1307 to predetermined subcarriers. The output of the channel selector 1308 is output from the antenna 1300 through a DAC (Digital Analog Converter) 1309 and an RF/IF section 1310.

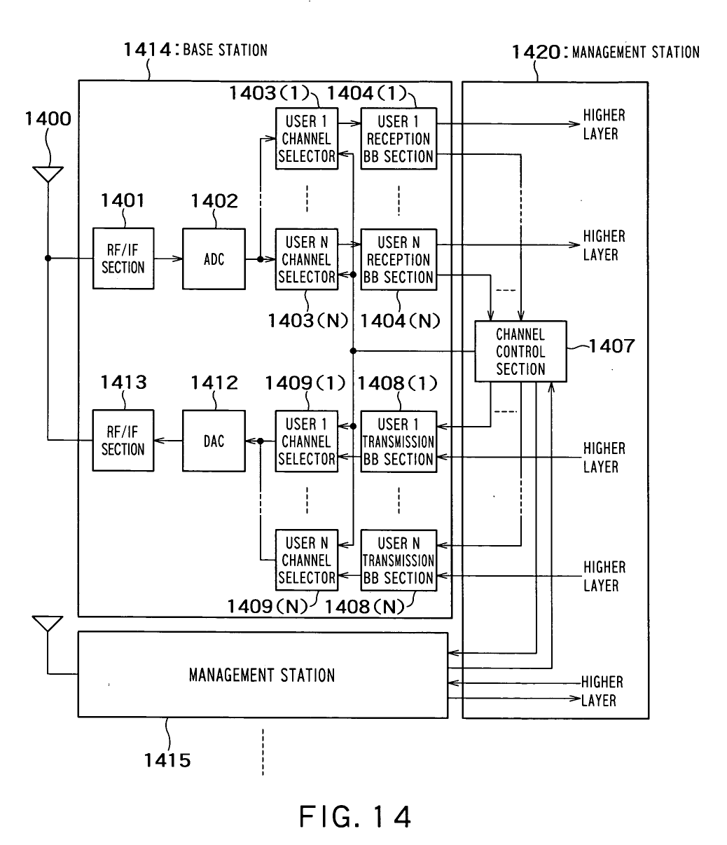

FIG. 14 is a block diagram showing the configuration of a base station and a management station as an embodiment of the present invention. Base stations 1414, 1415 . . . and a management station 1420 are shown.

Signals received at an antenna 1400 of the base station is frequency-converted at an RF/IF section 1401 and then converted to a digital signal at an ADC 1402. The output of the ADC 1402 is inputted to channel selectors 1403(1) to 1403(N) for their respective terminal devices. The channel selectors 1403(1) to 1403(N) select signals of subcarriers specified by a channel control section 1407 of the management station from among digital signals from the ADC 1402 and transfers them to reception BB sections 1404(1) to 1404(N). When there is no instruction from the channel control section 1407, for example, when a communication is started, the channel selectors 1403(1) to 1403(N) select signals of predetermined subcarriers and transfer them to the reception BB sections 1404(1) to 1404(N). The reception BB sections 1404(1) to 1404(N) perform transmission path estimation, demodulation, error correcting decoding or the like and transfer the data to higher layers. On the other hand, control signals of Measurement Report for judging subcarriers for communication are transferred to the channel control section 1407 of the management station. The channel control section 1407 of the management station receives Measurement Reports from the base stations, judges subcarriers for communication and notifies the information on subcarriers to be sent/received to the channel selectors 1403(1) to 1403(N), 1409(1) to 1409(N). The transmission BB sections 1408(1) to 1408(N) multiplex data signals from the higher layers and Reconfiguration Channel instruction or the like from the channel control section 1407, further perform processing such as error correcting coding and modulation and transfer the multiplexed signal to the channel selectors 1409(1) to 1409(N). The channel selectors 1409(1) to 1409(N) allocate the signals transferred from the transmission BB sections 1408(1) to 1408(N) to the subcarriers specified from the channel control section 1407. When there is no instruction from the channel control section 1407, when, for example, a communication is started, the channel selectors 1409(1) to 1409(N) allocate signals to predetermined subcarriers. The output of the channel selectors 1409(1) to 1409(N) are output from the antenna 1400 through a DAC 1412 and an RF/IF section 1413.

As described above, according to this embodiment, it is possible to secure a communication speed by carrying out a communication between a terminal located near a cell center and a base station using a subcarrier group for a cell central part, suppress inter-cell interference which is a problem with a 1-cell frequency repetition by carrying out communications between a terminal located near a cell edge and a plurality of base stations on a time-division scheme using subcarriers for a cell edge, and thereby improve throughput of the terminal which exists near the cell edge.

That is, it is judged whether or not a terminal device exists at a cell edge according to communication quality measured by the terminal device and if the terminal device exists at the cell edge, a plurality of base stations and the terminal device are made to communicate with each other on a time-division scheme using subcarriers for a cell edge, and therefore it is possible to suppress deterioration of the throughput of the terminal device which exists at the cell center, improve the communication quality of the terminal device which exists at the cell edge, and thereby improve the system throughput of the 1-cell frequency repetition multicarrier communication system.

Furthermore, according to this embodiment, subcarriers having a low frequency component are allocated to subcarriers for a cell edge by using the reflection and diffraction characteristics of a low frequency radio wave, and therefore it is possible to expand the cell area even with the same transmit power and thereby further improve the frequency utilization efficiency.

The present invention is not limited to the above described embodiments as they are, but can be implemented with the components thereof modified within a range not departing from the essence thereof in the implementation stage. Furthermore, various types of invention can also be formed through appropriate combinations of the plurality of components disclosed in the above described embodiments. For example, some components may be deleted from all the components shown in the embodiments. Moreover, it is also possible to combine components across different embodiments as appropriate.

What is claimed is:

1. A cellular communication system comprising:
a plurality of base stations whose respective communication areas partially overlap with each other and each of which uses a same frequency band;
a terminal device configured to communicate with the base stations; and
a management station configured to manage the base stations,
wherein the terminal device includes:
a signal quality measuring section configured to measure quality of signals from the base stations;
a first communication section configured to communicate with one of the base stations using first subcarriers out of subcarriers included in the same frequency band; and
a second communication section configured to communicate with two or more of the base stations on a time-division scheme using second subcarriers different from the first subcarriers out of the subcarriers included in the same frequency band,
each of the base stations includes:
a third communication section configured to communicate with the terminal device using the first subcarriers; and
a fourth communication section configured to communicate with the terminal device on the time-division scheme using the second subcarriers together with one or more other base stations;
the management station includes:
a quality information reception section configured to receive information indicating signal quality of the base stations measured at the terminal device from the terminal device through at least one base station with which the terminal device is communicating; and
a communication scheme determining section configured to
determine one or more base station to communicate with the terminal device based on the signal quality of the base stations,
transmit an instruction signal to instruct to communicate with the terminal device using the first subcarriers to a base station determined to communicate with the terminal device and transmit an instruction signal to instruct stoppage of communication to a base station determined not to communicate with the terminal device among the base stations with which the terminal device has communicated, when a change of the base stations to communicate with the terminal device occurs as a result of determination and the number of base station is one after the change, and
transmit an instruction signal to instruct to communicate between base stations determined to communicate with the terminal device and the terminal device using the second subcarriers to the base stations and transmit an instruction signal to instruct stoppage of communication to a base station determined not to communicate with the terminal in a case that the base station determined not to communicate with the terminal exists among the base stations with which the terminal device has communicated, when a change of the base stations to communicate with the terminal device occurs as the result of determination and the number of base stations is two or more after the change.

2. The system according to claim 1, wherein the communication scheme determining section selects highest signal quality out of signal quality pieces of the base stations and determines that a base station whose signal quality is low from the highest signal quality by a threshold or more does not communicate with the terminal device.

3. The system according to claim 1, wherein the communication scheme determining section selects highest signal quality out of signal quality pieces of the base stations and determines that a base station whose signal quality is within a threshold from the highest signal quality communicates with the terminal device.

4. The system according to claim 1, wherein the first subcarriers include H subcarriers on a high frequency side out of N subcarriers included in the same frequency band and the second subcarriers include N-H subcarriers on a low frequency side out of N subcarriers included in the same frequency band.

5. A management station of managing a plurality of base stations whose respective communication areas partially overlap with each other and each of which uses a same frequency band, comprising:
a quality information reception section configured to receive information indicating signal quality of signals which reach a terminal device from the base stations, through at least one base station with which the terminal is communicating; and
a communication scheme determining section configured to
determine one or more base station to communicate with the terminal device based on the signal quality of the base stations,
transmit an instruction signal to instruct to communicate with the terminal device using first subcarriers out of subcarriers included in the same frequency band to a base station determined to communicate with the terminal device and transmit an instruction signal to instruct stoppage of communication to a base station determined not to communicate with the terminal device among the base stations with which the terminal device has communicated, when a change of the base stations to communicate with the terminal device occurs as the result of determination and the number of base stations is one after the change,
transmit an instruction signal to instruct to communicate between base stations determined to communicate with the terminal device and the terminal device using second subcarriers different from the first subcarriers out of subcarriers included in the same frequency band to the base stations and transmit an instruction signal to instruct stoppage of communication to a base station determined not to communicate with the terminal device in a case that the base station determined not to communicate with the terminal device exists among the base stations which the terminal device has communicated, when a change of the base stations to communicate with the terminal device occurs as the result of determination and the number of base stations is two or more after the change.

6. The management station according to claim 5, wherein the communication scheme determining section selects highest signal quality out of signal quality pieces of the base stations and determines that a base station whose signal quality is low from the highest signal quality by a threshold or more does not communicate with the terminal device.

7. The management station according to claim 5, wherein the communication scheme determining section selects highest signal quality out of signal quality pieces of the base stations and determines that a base station whose signal quality is within a threshold from the highest signal quality communicates with the terminal device.

8. The management station according to claim 5, wherein the first subcarriers include H subcarriers on a high frequency side out of N subcarriers included in the same frequency band and the second subcarriers include N-H subcarriers on a low frequency side out of N subcarriers included in the same frequency band.

9. A communication control method executed in a cellular communication system which includes a terminal device and a plurality of base stations whose respective communication areas partially overlap with each other and each of which uses a same frequency band, comprising:
measuring signal quality of signals which reach the terminal device from the base stations;
determining one or more base station to communicate with the terminal device based on the signal quality of the base stations,
transmitting an instruction signal to instruct to communicate with the terminal device using first subcarriers out of subcarriers included in the same frequency band to a base station determined to communicate with the terminal device and transmitting an instruction signal to instruct stoppage of communication to a base station determined not to communicate with the terminal device among base stations with which the terminal have communicated, when a change of the base stations to communicate with the terminal device occurs as a result of the determining and the number of the base station is one after the change, and
transmitting an instruction signal to instruct to communicate between base stations determined to communicate with the terminal device and the terminal device using second subcarriers different from the first subcarriers out of subcarriers included in the same frequency band on a time-division scheme to the base stations and transmitting an instruction signal to instruct stoppage of communication to a base station determined not to communicate with the terminal device in a case that the base station determined not to communicate with the terminal device exits among base stations with which the terminal have communicated, when a change of the base stations to communicate with the terminal device occurs as a result of the determining and the number of base stations is two or more after the change.

10. The method according to claim 9, selecting highest signal quality out of signal quality pieces of the base stations and determining that a base station whose signal quality is low from the highest signal quality by a threshold or more does not communicate with the terminal device.

11. The method according to claim 9, selecting highest signal quality out of signal quality pieces of the base stations and determining that a base station whose signal quality is within a threshold from the highest signal quality communicates with the terminal device.

12. The method according to claim 9, wherein the first subcarriers include H subcarriers on a high frequency side out of N subcarriers included in the same frequency band and the second subcarriers include N-H subcarriers on a low frequency side out of N subcarriers included in the same frequency band.
